(19) United States
(12) Patent Application Publication
(10) Pub. No.: US 2002/0117443 A1
(43) Pub. Date: Aug. 29, 2002

(54) Sealed tight

(76) Inventors: Laura Jane Bailey, Hinesburg, VT (US); John Timothy Bailey, Hinesburg, VT (US)

Correspondence Address: Laura J. Bailey, PO Box 192, N. Ferrisburg, VT, 05473, US

(21) Appl. No.: 10/082,515

(22) Filed: Feb. 25, 2002

Related U.S. Application Data
(60) Provisional application No. 60/270,590, filed on Feb. 23, 2001.

(51) Int. Cl. C02F 3/32

(52) U.S. Cl. 210/602

(57) ABSTRACT

Sealed Tight is an integrated anaerobic digester and aquaculture filtering system for agricultural waste treatment. This systems retrofits existing waste containment facilities, resulting in an economical system for complete waste treatment that, due to its sealed design, protects the environment from contamination, even during flood situations. Thoroughly digested manure as created in this system is a superior, low-odor fertilizer. Aquatic plants used to filter overflow are excellent livestock feed; and stored biogas provides farms with a high level of energetic self-sufficiency.

This application claims benefit of provisional application No. 60/70,590 filed Feb. 23, 2001.

### CROSS-REFERENCE TO RELATED APPLICATIONS

Not-Applicable

### STATEMENT REGARDING FEDERALLY SPONSORED RESEARCH OR DEVELOPMENT

Not-Applicable

### REFERENCE TO SEQUENCE LISTING, A TABLE, OR A COMPUTER PROGRAM LISTING COMPACT DISC APPENDIX

Not-Applicable

### BACKGROUND OF THE INVENTION

Sealed Tight is an agricultural waste treatment system that uses psychrophilic anaerobic digestion to dispose of animal waste solids and aquatic plants to purify filtered effluent.

Psychrophilic anaerobic digestion has shown promise as a way to dispose of animal wastes. This is as described by Cullimore in the Agricultural Waste journal from December, 1985. The problem with existing systems is the inability to handle the volume of the waste stream of ever-expanding facilities. These are hopper-type digesters.

Existing methane capturing systems are floating systems, fitted with pockets to capture biogas, and cover systems. These systems contain an atmosphere of biogas equal to or higher than our own. They are subject to wind damage and are at danger in flood situations.

Aquatic plant filtering of degraded water has been proven to be as effective as conventional sewage treatment systems, as shown in the work of Wolverton in the 1980's. The problem with this type of system is that it is limited by climate, and is primarily used for aquaculture of fish. Existing systems are designed to use plants as the primary filter of degraded water.

### BRIEF SUMMARY OF THE INVENTION

Sealed Tight is a sealed system that converts existing waste storage systems into anaerobic digesters. Sealed Tight decreases the dangers of environmental contamination from agricultural waste and reduces the amounts of contaminants released. The capacity created by converting existing pit into a digester, and longer holding time, causes manure to be more thoroughly digested than in existing systems. Finished slurry is of a greater grade, increasing the availability of nutrients to plants, thus adding value. Sealed Tight provides a complete waste treatment system and an economical solution to the dangers of agricultural waste contamination.

Sealed Tight uses vacuum for ballast, eliminating the danger of wind damage to the membrane. Vacuum pressure also eliminates the danger of the membrane lifting off the pit in a flood situation.

Sealed Tight is a complete waste treatment system. Aquatic plants are used to treat filtered effluent from the digester. The plants are contained in a lined, covered canal to decrease ground water contamination and dangers of flooding.

### BRIEF DESCRIPTION OF THE SEVERAL VIEWS OF THE DRAWINGS

FIG. 1A Cross-Section View of the Sealed Tight system

1 End view of overflow canal

2 Greenhouse over canal

3 Micro-filter to filter effluent

4 Valves to control the flow of effluent

5 Pipe to pump gas to storage

6 Concrete retaining wall around pit

7 Emergency Photovoltaic Pump

8 Pressure switch to control pressure in digester

9 Diaphragm Membrane

10 Drain for finished sludge

11 Inlet for waste

12 Augers

13 Valve to seal system in flood stage

FIG. 2A Cross-section of Overflow Canal

FIG. 2B End View of Overflow Canal

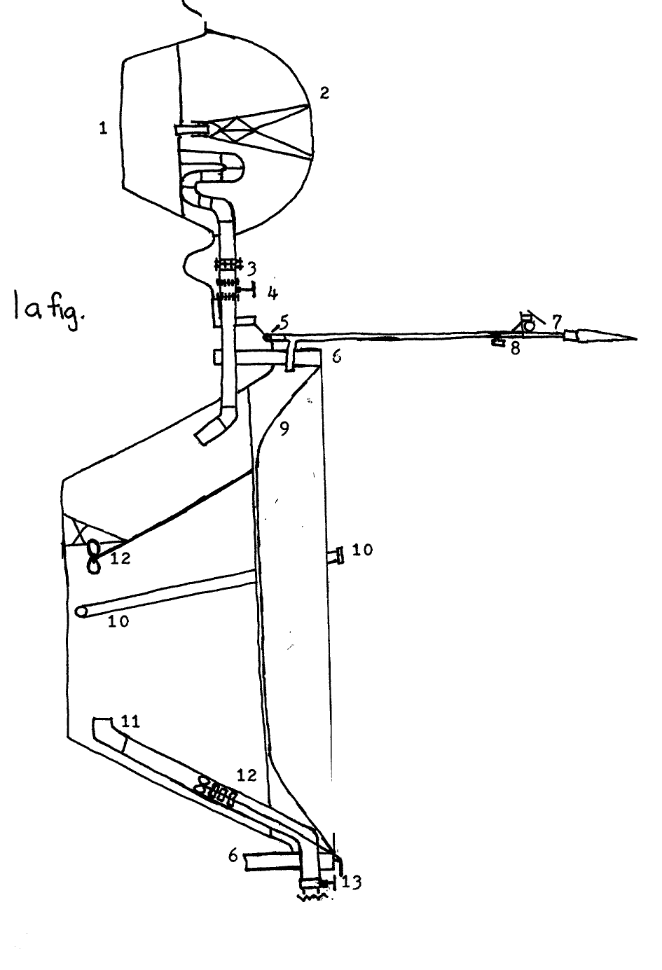

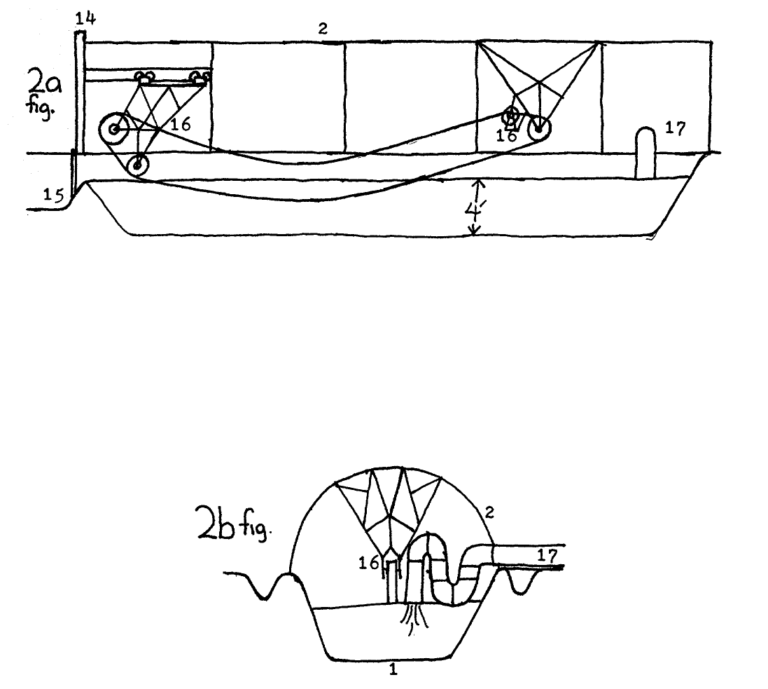

14 Doors to Greenhouse

15 Spillway for Canal

16 Overhead Harvester

17 Effluent Inlet

### DETAILED DESCRIPTION OF THE INVENTION

Sealed Tight is a continuous flow, psychrophilic anaerobic digester, micro-filtration, integrated aquaculture waste treatment system that eliminates the danger of flood damage. Sealed Tight converts existing manure pits into anaerobic digesters and uses aquatic plants in an overflow canal to convert nutrient-rich effluent into feed for livestock.

The anaerobic digester consists of an airtight diaphragm secured to a concrete beam. The diaphragm is kept under negative pressure for ballast, for protection during flood situations. Pressure is regulated by a pressure switch located on the vent to keep the digester under vacuum. The perimeter beam is plumbed to receive waste stream, to pump off biogas, to provide for effluent overflow, and to remove fully processed slurry. The pipe for incoming waste is fitted with an auger sufficient to mix and distribute waste throughout the pit. Augers will also be placed at other points in the digester. The number and placement of the augers will be dependent on the size and shape of the pit. Biogas is pumped into a storage tank and an emergency photovoltaic pump is located on the vent, above flood stage, to flair off gas during a flood. Valves are located on an overflow pipe to control the flow of effluent, to allow for the settling of slurry in the digester before effluent is released.

Effluent then flows through a micro-filter, separating out solids. Once through the micro-filter, effluent flows into one end of the adjacent canal, which is lined to prevent ground water contamination. The nutrient-rich water is filtered by the growth of aquatic plants. The purified water flows out the other end of the canal.

The overflow canal is four feet deep, the average length of the feather-like roots of the water hyacinth. The overflow canal has a surface area of at least one eighth that of the digester. Water hyacinth has been shown to effectively treat water prior to release in the environment. The canal is covered by a hoop-type greenhouse to divert rainwater into adjacent ditches, and to protect the tropical plants during the cold season. The greenhouse is also enclosed to prevent the spread of water hyacinth into the ecosystem. An overhead conveyor belt is suspended from the ceiling; it is used to push plants out the end of the canal to be harvested.

Sealed Tight will not interfere with normal operations of the farm. The farmer will continue to dispose of manure using existing procedures and equipment. The farmer must only close the overflow valve before sending manure into the pit and run augers for at least thirty minutes each cleaning. The farmer must allow at least eight hours for settling before opening the overflow valve. The farmer will harvest plants periodically, depending on growth. To harvest, the farmer will open the doors to the greenhouse and extend the conveyor out the end of the greenhouse. The farmer will then turn on the conveyor, which will push plants over the spillway. The plants will then be used for feed.

What we claim as our invention is:

1. A continuous flow, psychrophilic anaerobic digester, micro-filtration, integrated aquaculture waste treatment system comprised of:
a. an anaerobic digester to capture waste, fitted with augers to mix digested slurry with waste stream.
b. valves to control the flow of effluent to allow sludge to settle before effluent is released.
c. micro-filter to filter solids and pathogens from effluent
d. aquatic plants for filtering of effluent

2. A system according to claim 1 where valve for effluent is closed before receiving waste stream

3. A system according to claim 1 where waste is mixed daily with augers.

4. A system, according to claim 1, where waste is allowed to settle at least eight hours before opening valve to allow effluent to flow out.

5. A system that converts existing manure pits, lagoons, into anaerobic digesters by covering the pit with an airtight diaphragm secured to a concrete beam, where diaphragm is kept under negative pressure for ballast.

6. A system according to claim 5 that protects against environmental contamination by removing the danger of the diaphragm being lifted by biogasses in floodstage.

7. A system according to claim 5 where concrete beam is plumbed to receive waste, to pump off bio-gas, to provide for effluent overflow, and to remove finished slurry.

8. A system according to claim 5 where bio-gas is pumped off into storage and an emergency photovoltaic pump located on vent is used during floodstage.

9. A system of aquatic plant filtering of effluent, the system comprised of:
a. an canal adjacent to digester
b. canal is lined and covered with a greenhouse
c. an overhead conveyor harvester

10. A system according to claim 9 where canal is lined to prevent ground water contamination.

11. A system according to claim 9 where nutrient rich effluent flows into 1 end of canal and purified water out other end.

12. A system according to claim 9 that removes nutrients and antibiotics by filtering with the use of aquatic plants.

13. A system according to claim 9 where greenhouse is used to prevent the spread of aquatic plants into ecosystem.

14. A system according to claim 9 where greenhouse is used to protect aquatic plants from climate.

15. A system according to claim 9 where harvester is suspended from greenhouse to harvest aquatic plants.

16. A system according to claim 9 where harvester is of a conveyor type system.

17. A system according to claim 12 where aquatic plants used as feed decreases the amount of antibiotics administered to animals.
